(19) United States
(12) Patent Application Publication
(10) Pub. No.: US 2018/0273408 A1
(43) Pub. Date: Sep. 27, 2018

(54) WASTEWATER DENITRIFICATION METHOD UTILIZING RECYCLING OF NITRIFIED TREATED EFFLUENT

(71) Applicant: NEXOM, Winnipeg (CA)

(72) Inventors: Martin Hildebrand, Winnipeg (CA); Merle Kroeker, Winnipeg (CA)

(21) Appl. No.: 15/723,451

(22) Filed: Oct. 3, 2017

Related U.S. Application Data
(60) Provisional application No. 62/403,361, filed on Oct. 3, 2016.
(60) Provisional application No. 62/426,383, filed on Nov. 25, 2016.

(51) Int. Cl. C02F 3/30

(52) U.S. Cl. CPC C02F 3/305; C02F 2101/163

(57) ABSTRACT

Described herein is a wastewater treatment process comprising an anoxic zone upstream of an attached growth reactor wherein a portion of nitrified waste from the attached growth reactor is recycled to a point in the treatment process that is upstream of at least part of the anoxic zone rather than being released from the system. As a result, the influent wastewater and the recycled effluent mix together and are nitrified and denitrified as they progress through the waste treatment system. The key aspect of this process is that the nitrate-rich, effluent water is returned to the anoxic reactor for (additional) denitrification of the wastewater.

### PRIOR APPLICATION INFORMATION

The instant application claims the benefit of U.S. Provisional Patent Application Ser. No. 62/403,361, filed Oct. 3, 2016, entitled “SUBMERGED ATTACHED GROWTH REACTOR”, the contents of which are incorporated herein by reference.

The instant application also claims the benefit of U.S. Provisional Patent Application Ser. No. 62/426,383, filed Nov. 25, 2016, entitled “SUBMERGED ATTACHED GROWTH REACTOR”, the contents of which are incorporated herein by reference.

### BACKGROUND OF THE INVENTION

Compounds such as organic matter and nitrogen contained in wastewater are capable of being oxidized and transformed by bacteria which use these compounds as a food source.

Wastewater is generally defined as any domestic, municipal or industrial liquid waste.

Typically, heterotrophic bacteria digest the organic matter while nitrifying bacteria use the non-carbon compounds, for example, oxidizing ammonia to nitrate (a process known as nitrification).

Following nitrification of the wastewater to convert ammonia into nitrates, the nitrates can be denitrified to nitrogen gas.

Nitrate(NO₃⁻)→Nitrite(NO₂⁻¹)→Nitric Oxide(NO)→Nitrous Oxide(N₂O)→N₂ gas

Denitrification must take place under conditions where oxygen, a more energetically favorable electron acceptor, is near or at depletion.

In some wastewater treatment methods and systems, a carbon source, for example, methanol, ethanol, acetate, glycerin or the like is added to the wastewater as a food source for the denitrifying bacteria.

Denitrification is an important step in the water treatment process as it removes the final nitrogen components, nitrites and nitrates, from wastewater after the nitrification process.

In the final stage of nitrogen removal, denitrification, microbes convert the nitrates to nitrogen gas where it is finally released to the atmosphere. This step is important because nitrates in water are still dangerous to aquatic life and potentially harmful to humans if they are present in groundwater and drinking water. As more waste water treatment plants consider ground water discharge, this denitrification treatment step is critical to the health and well-being of the local population.

### SUMMARY OF THE INVENTION

According to an aspect of the invention, there is provided a method of reducing total nitrogen levels in discharged effluent comprising:

in a sewage treatment system comprising an attached growth reactor and an upstream reactor comprising an anoxic zone, said upstream reactor comprising an inlet for receiving an incoming wastewater volume and an outlet for discharging treated waste, said attached growth reactor comprising an inlet for receiving treated waste from the upstream reactor and an outlet for discharging treated effluent from the attached growth reactor,

transferring an influent volume of treated waste to the attached growth reactor at said inlet,

over a period of time, converting ammonia in said influent to nitrate, thereby producing treated influent,

discharging said treated influent from the attached growth reactor as treated effluent, said discharged treated effluent comprising a recycling volume and a discharge volume,

transferring said recycling volume at a position upstream of at least a portion of the anoxic zone of the upstream reactor, wherein said recycling volume corresponds to 0.5× to 10× of the incoming wastewater volume, and

discharging the discharge volume of the treated effluent.

In some embodiments, the discharge volume of the treated effluent has a total nitrogen (TN) level that is less that the total Kjedahl nitrogen (TKN) level or total nitrogen level of the incoming wastewater. For example, the TN level of the discharge volume may be reduced compared to the total nitrogen level of the incoming wastewater by at least 30%, by at least 40% or by at least 50%.

According to an aspect of the invention, there is provided a method of reducing nitrate levels in discharged effluent comprising:

in a sewage treatment system comprising an attached growth reactor and an upstream reactor comprising an anoxic zone, said upstream reactor comprising an inlet for receiving an incoming wastewater volume and an outlet for discharging treated waste, said attached growth reactor comprising an inlet for receiving the treated waste from the upstream reactor and an outlet for discharging treated effluent from the attached growth reactor, said treated effluent comprising a recycling volume and a discharge volume,

transferring an influent volume of treated waste to the attached growth reactor at said inlet,

transferring the recycling volume of treated effluent from the outlet of the attached growth reactor to a position upstream of the anoxic zone of the upstream reactor, said recycling volume corresponding to 0.5× to 10× of the incoming wastewater volume, and

discharging the discharge volume of the treated waste.

In some embodiments, the discharge volume of the treated effluent has a total nitrogen (TN) level that is less that the total Kjedahl nitrogen (TKN) level or total nitrogen level of the incoming wastewater. For example, the TKN level of the discharge volume may be at least 30% less than, at least 40% less than or at least 50% less than the TKN level or total nitrogen level of the incoming wastewater volume.

As discussed herein, in some embodiments, the an anoxic zone is a zone within a primary or secondary treatment component in the sewage treatment system where anoxic conditions exist. In these embodiments, the upstream reactor would also comprise the corresponding primary or secondary treatment component. However, in other embodiments, the upstream reactor comprising the anoxic zone may be a stand-alone anoxic reactor.

As will be apparent to those of skill in the art of water and sewage treatment, the upstream reactor may comprise or be selected from for example but by no means limited to one or more lagoons, septic tanks, mechanical plants, attached growth reactors, clarifiers and the like as well as combinations thereof.

According to another aspect of the invention, there is provided a wastewater treatment system comprising:

an upstream reactor comprising:
an inlet arranged to accept an incoming volume of wastewater;
an anoxic zone downstream of the inlet; and
an outlet for discharging a volume of treated wastewater;

an attached growth reactor comprising:
an inlet for receiving treated wastewater from the upstream reactor; and
at least one outlet for releasing a treatment volume of the treated wastewater from the attached growth reactor; and

a recycling system arranged to transfer a portion of the treatment volume from the attached growth reactor to a point in the upstream reactor upstream of the anoxic zone.

### BRIEF DESCRIPTION OF THE DRAWINGS

FIG. 1 is a graph showing levels of nitrates, nitrites, total nitrogen and TKN over time as a result of effluent recycling.

FIG. 2 is a side view of the wastewater treatment system.

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

As used herein, ‘heterotrophic bacteria’ refers to bacteria capable of utilizing organic material. It is of note that generas of such bacteria are well known within the art and one of skill in the art will understand that this refers to specific bacteria of this type known to be present in for example treatment lagoons.

As used herein, “nitrifying bacteria” refers to bacteria capable of oxidizing ammonia to nitrate. It is of note that such bacteria are well known within the art and one of skill in the art will understand that this refers to specific bacteria of this type known to be present in for example components of wastewater treatment facilities and plants.

Described herein is an improved sewage treatment process which comprises an attached growth reactor and an upstream reactor comprising an anoxic zone.

The anoxic zone comprises a zone where anoxic conditions exist. As discussed herein, the anoxic zone may be a stand-alone anoxic reactor or an anoxic basin and/or may be within a primary or secondary treatment component in the sewage treatment system.

The anoxic zone, creates an environment with minimal dissolved oxygen, which provides the heterotrophic bacteria with an ideal environment for denitrification. The lack of dissolved oxygen forces the microbes to acquire elemental oxygen from the nitrates and nitrites, which in turn results in the release of nitrogen gas to the atmosphere. The microbes in the anoxic zone also require food in the form of carbon, which they receive from CBOD in the influent or raw waste water also entering that anoxic zone. The final byproducts of this denitrification process are OH⁻, energy and nitrogen gas (N₂).

In some embodiments, the wastewater treatment process or system includes a secondary treatment component, for example but by no means limited to lagoons, septic tanks, mechanical plants, attached growth reactors, clarifiers and the like as well as combinations thereof.

In some embodiments, the sewage treatment process comprises a wastewater lagoon as the secondary treatment component, which provides primary and secondary treatment (BOD and TSS removal) of municipal or industrial wastewater. Utilizing a lagoon provides flow buffering, along with low operation and maintenance requirements. Effluent from the lagoon, with low BOD and low TSS but variable nitrogen levels, passes through an attached growth reactor for nitrification. However, nitrified effluent may be high in nitrates or nitrites.

However, as discussed herein, transferring or recycling a portion of the treated effluent from the attached growth reactor allows for increased or improved removal of total nitrogen from the wastewater.

Specifically, a portion of the effluent from the attached growth reactor is returned to an anoxic basin or an anoxic zone within a basin near the front or start of the overall treatment system for denitrification. As discussed herein, the primary influent entering the anoxic basin consists of raw wastewater, or minimally treated wastewater which is high in BOD, and may be low in oxygen. However, the nitrified effluent from the attached growth reactor may be high in oxygen, bound in the form of nitrates or nitrites.

As a result of the recycling of the treated effluent, bacteria in the wastewater present in the anoxic zone of the upstream reactor consume the BOD from the raw wastewater, utilizing the nitrates from the treated effluent or recycle stream as an oxygen source. Consuming the oxygen from the nitrates releases nitrogen from the wastewater as nitrogen gas. The denitrification reaction uses up BOD, which in turn lowers energy requirements for BOD removal elsewhere in the treatment plant. Utilizing BOD present in the influent wastewater as a carbon source for the denitrification reaction also reduces or eliminates the need to add a carbon source to the reactor. As such, the efficiency of the entire wastewater treatment process is increased and the treated effluent is much more environmentally acceptable as it is lower in nitrogen.

In some embodiments, the attached growth reactor is a submerged attached growth reactor (SAGR), a moving media attached growth reactor (MMAGR) or a stationary media attached growth reactor (SMAGR). One example of an MMAGR is a Moving Bed Biofilm Reactor (MBBR), as discussed below. One example of a SMAGR is a stationary fixed film media attached growth reactor, as discussed below. However, as will be appreciated by one of skill in the art, any suitable growth reactor which receives an influent that undergoes bacterial nitrification can be used in combination with the present disclosure.

It is of note that there are many possible arrangements that will result in a reactor having a functionality similar to a SAGR or MBBR which will be readily apparent to one of skill in the art.

In some embodiments, the SAGR includes a media bed for example, a gravel or rock (or other similar material) bed with one or more horizontal chambers throughout. The chamber system is used to distribute the wastewater flow across the width of the cell, and a horizontal collection chamber at the outlet of the system is used to collect treated water. This distribution is desired to ensure horizontal flow throughout the gravel media and optimize hydraulic efficiency, although alternate (vertical) flow paths could achieve similar treatment results, and are contemplated by this invention. Linear aeration proximate to the bottom of the SAGR provides aerobic conditions that are required for nitrification. In some embodiments, the gravel bed may be covered with a layer of an insulating material, for example, peat or wood chips.

As noted above, one example of an MMAGR is an MBBR. In an MBBR, the media is generally of similar density to water, typically plastic or other synthetic materials that are suitable for attached bacterial growth, and is in suspension. Mixing using aeration or mechanical mixers keeps the media circulating throughout the reactor and the entire reactor functions as a completely mixed reactor. Because the water volume/media/biomass volume is homogenous in the reactor, location of the influent and effluent points is not critical. That is, the influent and effluent points can either be separated by distance or can be close together. Typically, biomass will be dispersed across all media in the reactor. Generally, rock is not used in an MBBR because it is too heavy and cannot be kept in suspension by mixing.

As discussed above, one example of an SMAGR is a stationary fixed film media attached growth reactor. This stationary film does not require energy for suspension. Some examples of stationary fixed film media include but are by no means limited to GE Membrane Aerated Bioreactor (MABR), Entex Webitat fixed film media, and Lemna Polishing Reactor (LPR). While it is not necessary for the media to remain in suspension, full mixing within the reactor is possible. In this case, because of the mixing, influent and effluent locations can vary considerably and, similar to an MBBR, there is no minimum distance requirement. As is the case with the MBBR, physical barriers may be required to have distinct hydraulic zones within the system, as discussed above, although a hydraulic gradient could be used instead, provided the mixing of the suspension is at a suitable level for the hydraulic gradient to function.

According to an aspect of the invention, there is provided a method of reducing total nitrogen levels in discharged effluent comprising: in a sewage treatment system comprising an attached growth reactor and an upstream reactor comprising an anoxic zone, said upstream reactor comprising an inlet for receiving an incoming wastewater volume and an outlet for discharging treated waste, said attached growth reactor comprising an inlet for receiving treated waste from the upstream reactor and an outlet for discharging treated effluent from the attached growth reactor, transferring an influent volume of treated waste to the attached growth reactor at said inlet, over a period of time, converting ammonia in said influent to nitrate, thereby producing treated influent, discharging said treated influent from the attached growth reactor as treated effluent, said discharged treated effluent comprising a recycling volume and a discharge volume, transferring said recycling volume at a position upstream of at least a portion of the anoxic zone of the upstream reactor, wherein said recycling volume corresponds to 0.5× to 10× of the incoming wastewater volume, and discharging the discharge volume of the treated effluent.

In some embodiments, the discharge volume of the treated effluent has a total nitrogen (TN) level that is less that the total Kjedahl nitrogen (TKN) level or total nitrogen level of the incoming wastewater. For example, the TN level of the discharge volume may be reduced compared to the total nitrogen level of the incoming wastewater by at least 30%, by at least 40% or by at least 50%.

In some embodiments, the discharge volume of the treated effluent has a total nitrogen (TN) level that is less that the total Kjedahl nitrogen (TKN) level or total nitrogen level of the incoming wastewater. For example, the TN level of the discharge volume may be reduced compared to the total nitrogen level of the incoming wastewater by at least 30%, by at least 40% or by at least 50%.

For reference purposes, in some embodiments, the incoming wastewater may have a total Kjeldahl nitrogen (TKN) of between 5-60 mg/L It is important to note that the discharge volume of the effluent treated by the method, process and/or system described herein will also have a total nitrogen (TN) level that is less that the total nitrogen level of an effluent treated by a comparable wastewater treatment system receiving and treating a comparable wastewater but in which there is no recycling volume returned to an upstream reactor. For example, the TN level of the discharge volume may be reduced compared to the TN level of the treated effluent of the comparable prior art wastewater treatment system by at least 30%, by at least 40% or by at least 50%.

As discussed herein, the attached growth reactor may be selected from the group consisting of: a submerged attached growth reactor (SAGR), a moving media attached growth reactor (MMAGR) and a stationary media attached growth reactor (SMAGR). In some embodiments, the attached growth reactor is a submerged attached growth reactor.

In some embodiments, the upstream reactor comprising the anoxic zone is an anoxic reactor or an anoxic basin. In some of these embodiments, the attached growth reactor is a SAGR.

In some embodiments, the anoxic zone is within a lagoon, although as discussed herein, other waste treatment components known in the art capable of supporting an anoxic zone may be used within the invention.

In other embodiments, there is provided a secondary treatment component that receives treated waste from the upstream reactor comprising the anoxic zone and discharges secondary treated waste to the attached growth reactor.

The secondary treatment component may be, for example but by no means limited to one or more lagoons, septic tanks, mechanical plants, attached growth reactors, clarifiers and the like as well as combinations thereof.

In some embodiments, the secondary treatment component is a lagoon.

While any suitable attached growth reactor may be used in these embodiments of the invention, in some embodiments, the attached growth reactor is a SAGR.

According to another aspect of the invention, there is provided a method of reducing total nitrogen levels in discharged effluent comprising: in a sewage treatment system comprising an attached growth reactor and an upstream reactor comprising an anoxic zone, said upstream reactor comprising an inlet for receiving an incoming wastewater volume and an outlet for discharging treated waste, said attached growth reactor comprising an inlet for receiving the treated waste from the upstream reactor and an outlet for discharging treated effluent from the attached growth reactor, said treated effluent comprising a recycling volume and a discharge volume, transferring an influent volume of treated waste to the attached growth reactor at said inlet, transferring the recycling volume of treated effluent from the outlet of the attached growth reactor to a position upstream of the anoxic zone of the upstream reactor, said recycling volume corresponding to 0.5× to 10× of the incoming wastewater volume, and discharging the discharge volume of the treated waste.

In some embodiments, the upstream reactor comprising the anoxic zone is an anoxic reactor or an anoxic basin. In some of these embodiments, the attached growth reactor is a SAGR.

In some embodiments, the anoxic zone is within a lagoon, although as discussed herein, other waste treatment components known in the art capable of supporting an anoxic zone may be used within the invention.

In other embodiments, there is provided a secondary treatment component that receives treated waste from the upstream reactor comprising the anoxic zone and discharges secondary treated waste to the attached growth reactor.

The secondary treatment component may be, for example but by no means limited to one or more lagoons, septic tanks, mechanical plants, attached growth reactors, clarifiers and the like as well as combinations thereof.

In some embodiments, the secondary treatment component is a lagoon.

While any suitable attached growth reactor may be used in these embodiments of the invention, in some embodiments, the attached growth reactor is a SAGR.

According to another aspect of the invention, there is provided a wastewater treatment system comprising:

an upstream reactor comprising:
an inlet arranged to accept an incoming volume of wastewater;
an anoxic zone downstream of the inlet; and
an outlet for discharging a volume of treated wastewater;

an attached growth reactor comprising:
an inlet for receiving treated wastewater from the upstream reactor; and
at least one outlet for releasing a treatment volume of the treated wastewater from the attached growth reactor; and

a recycling system arranged to transfer a portion of the treatment volume from the attached growth reactor to a point in the upstream reactor upstream of the anoxic zone.

As will be appreciated by one of skill in the art, the upstream reactor and the attached growth reactor may be connected by any suitable fluid transportation system such as for example pipes known in the art.

As will be apparent to one of skill in the art, the recycling system may be connected to the upstream reactor at any of a variety of locations. For example, the recycling system may use the same inlet as the incoming wastewater or may discharge the recycling volume of the treatment waste at any other suitable point within the upstream reactor between the inlet and at least a portion of the anoxic zone. As will be apparent to one of skill in the art, the recycling volume must pass through a sufficient area of the anoxic zone for at least some denitrification to take place. Exposing the recycling volume to more of the anoxic zone will of course result in greater denitrification. Furthermore, depending on the specific structure of the upstream reactor, the recycling volume may be discharged into the upstream reactor at a position that is upstream of the inlet.

Similarly, the recycling volume may be removed from the attached growth reactor at any suitable location within the attached growth reactor wherein sufficient nitrification of the wastewater being treated will have occurred, in some embodiments, this may be the outlet of the attached growth reactor or a location close to the “end” of the attached growth reactor, but this is not essential.

As discussed above, the attached growth reactor is selected from the group consisting of: a submerged attached growth reactor (SAGR), a moving media attached growth reactor (MMAGR) and a stationary media attached growth reactor (SMAGR). In some embodiments, the attached growth reactor is a submerged attached growth reactor.

In some embodiments, the upstream reactor comprising the anoxic zone is an anoxic reactor or an anoxic basin. In some of these embodiments, the attached growth reactor is a SAGR.

In some embodiments, the anoxic zone is within a lagoon, although as discussed herein, other waste treatment components known in the art capable of supporting an anoxic zone may be used within the invention.

In other embodiments, there is provided a secondary treatment component that receives treated waste from the upstream reactor comprising the anoxic zone and discharges secondary treated waste to the attached growth reactor.

The secondary treatment component may be, for example but by no means limited to one or more lagoons, septic tanks, mechanical plants, attached growth reactors, clarifiers and the like as well as combinations thereof.

In some embodiments, the secondary treatment component is a lagoon.

While any suitable attached growth reactor may be used in these embodiments of the invention, in some embodiments, the attached growth reactor is a SAGR.

The variation in levels of wastewater entering treatment systems over time are well understood by those knowledgeable in the art in general as well as specifically for individual treatment systems. Accordingly, the mixing of 0.5× to 10× volumes of treated effluent to 1× volume of incoming wastewater may not or need not be measured precisely but may be estimated based on expected or anticipated volumes.

As discussed herein, it has been discovered that by recycling a volume of the treated effluent exiting the attached growth reactor to a point in the treatment system that is upstream of at least a portion of the anoxic zone within the upstream reactor, so that when progressing through the wastewater system, the recycled volume passes through at least a portion of the anoxic zone prior to returning to the attached growth reactor. In some embodiments, the recycling volume is transferred to the inlet end of the primary or secondary treatment process such that the influent wastewater and the recycled effluent mix together and are nitrified and denitrified, as discussed herein although as discussed herein, the recycling volume may be transferred to any location upstream of at least a portion of the anoxic zone, provided that the recycling volume will be exposed to enough of the anoxic zone for sufficient denitrification to occur.

As discussed herein, the key aspect of this process is that the nitrate-rich, treated effluent is returned to the upstream reactor for (additional) denitrification. As discussed above, the nitrates provide oxygen for denitrification which reduces BOD levels in the wastewater while also converting nitrates to nitrogen gas that would otherwise be discharged from the attached growth reactor.

As discussed below in the Examples section, as a result of recycling a portion of the effluent from the attached growth reactor back to a point of the wastewater treatment system that is upstream of at least a portion of the anoxic zone of the upstream reactor, the TKN of the discharge effluent was reduced, specifically, to approximately half that of the incoming influent, specifically, by approximately 68%. It is of note that this was accomplished using a 0.95× recycling volume. As will be appreciated by one of skill in the art, this indicates that greater reductions can be achieved with greater recycling volumes, as discussed herein.

Furthermore, it is noted that in some embodiments, particularly wherein the TKN of the incoming wastewater is particularly high, the discharge volume from the attached growth reactor may be transferred or discharged to another unit process for further denitrification.

Typically, influent into the treatment system or anoxic basin will typically be raw wastewater, comprising CBOD 150-250 mg/l; TSS 150-250 mg/l; total Kjeldahl Nitrogen (TKN) 25-45 mg/l; ammonia 20-40 mg/l; and total phosphorus 6-8 mg/l.

Effluent entering the attached growth reactor, for example, a SAGR, typically has estimated concentrations of CBOD5 20-40 mg/l; total suspended solids (TSS) 20-40 mg/l; and TKN of approximately 15-45 mg/l.

The length of the SAGR is typically 40-75 ft long with a depth of between 4-12 ft. The width of the SAGR will vary as a function of flow. For example, more influent flow from a larger population base will result in a wider system. Retention time of the wastewater in the SAGR is a function of wastewater concentration.

A treatment lagoon will typically have a depth between 5 and 20 ft and will typically have somewhere between 20 and 45 days of retention time for the wastewater. The volume of the lagoons depends on the population base feeding the lagoon.

As is apparent to one of skill in the art, depending on the local regulations, the prior art teaches that the attached growth reactor effluent is either released or discharged or is transferred to a dedicated denitrification system.

However, surprisingly, as discussed above, it has been found that under certain influent conditions, for example, when the average TKN of the waste water or influent entering the SAGR 5-60 mg/L or 60 mg/L or less, 50 mg/L or less, 40 mg/L or less, is 35 mg/L or less or 30 mg/L or less, or 25 mg/L or less or 20 mg/L or less, applying a quantity of the effluent exiting the SAGR back to the influent entry point for the treatment system upstream of the anoxic zone results in not only nitrification of the contents of the SAGR but sufficient denitrification as well, as discussed herein.

The amount of effluent returned to the influent entry point depends on a variety of factors, including but by no means limited to the average TKN and BOD of the influent entering the attached growth reactor and/or of the material entering the anoxic reactor and/or the desired TN of the effluent being discharged from the attached growth reactor.

In the invention, the volume of recycled effluent, that is, effluent from the attached growth reactor returned upstream of the anoxic reactor in the treatment process, that is, for example, to the front primary or secondary treatment process, varies from 0.5 (or 50%) to 10× (or 1000%) of the volume of the wastewater influent entering the treatment system. In typical embodiments, the volume of recycled effluent is typically 50-300% of influent, for example, raw wastewater or sewage, entering the treatment system.

As will be appreciated by one of skill in the art, there are many ways to redirect either a portion or all of the effluent exiting the attached growth reactor so that a volume of the effluent corresponding to 0.5× to 10× is recycled to a point upstream of the anoxic reactor, for example, to the influent entry point of the primary or secondary treatment process which will be readily apparent to one of skill in the art of water treatment and processing.

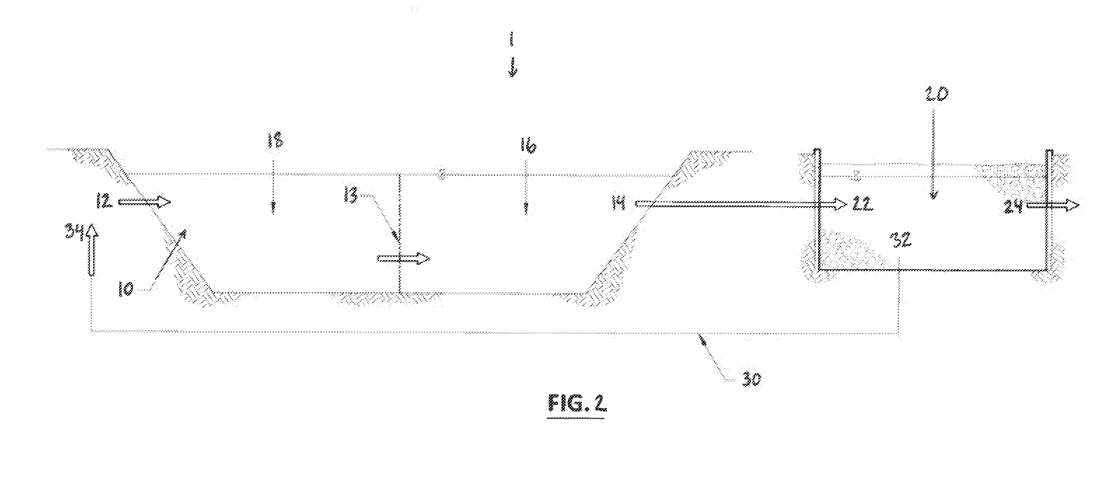

Shown in FIG. 2 is a wastewater treatment system 1 comprises an upstream reactor 10, an attached growth reactor 20 and an effluent recycling system 30.

In the embodiment shown in FIG. 2, the upstream reactor 10 is a lagoon 11, although other suitable upstream reactors may be used in the wastewater treatment system 1 provided that they have a suitable anoxic zone, as discussed herein. The lagoon 11 has an inlet 12 which receives an incoming volume of wastewater to be treated and an outlet 14. The lagoon 11 also comprises an anoxic zone 18 and an aerated zone 16. As shown in FIG. 2, the anoxic zone 18 and the aerated zone 16 are separated by a barrier 13. The barrier may be any suitable barrier, for example, a hydraulic gradient or a physical barrier. The upstream reactor is also arranged to accept recycled treated effluent from the attached growth reactor 20 via the effluent recycling system as discussed herein. The upstream reactor 10 has an anoxic zone 18, as shown in FIG. 2.

The attached growth reactor 20 comprises an inlet 22 that is connected to the outlet 14 of the lagoon 11 for receiving treated wastewater and an outlet 24. It is of note that the attached growth reactor 20 shown in FIG. 2 is a submerged attached growth reactor (SAGR) although as discussed herein, any suitable attached growth reactor or reactor having similar functionality may be used within the wastewater treatment system.

The effluent recycling system 30 is arranged to transfer treated effluent from the attached growth reactor 20 to the lagoon 11.

As will be appreciated by one of skill in the art, the location at which the treated effluent is removed from the attached growth reactor will depend on the specific type of attached growth reactor being used. In some embodiments, the treated effluent is removed at the outlet 24. Alternatively, as shown in FIG. 2, the effluent recycling system 30 may have a recycling inlet 32 separate from the inlet 24.

The effluent recycling system 30 has a recycling discharge outlet 34. In the embodiment shown in FIG. 2, the recycling discharge outlet 34 is connected to the inlet 12 of the lagoon 11; however, this is not essential and as discussed herein the recycling discharge outlet 34 may be arranged to discharge recycled treated effluent at any location within the upstream reactor 10 that is upstream of a portion of the anoxic zone 18, as discussed herein.

In use, as discussed herein, transferring or recycling a portion of the treated effluent from the attached growth reactor back to the upstream reactor allows for increased or improved removal of nitrogen from the wastewater.

Specifically, municipal or industrial wastewater enters the upstream reactor 10 via inlet 12. Treatment of the wastewater in the upstream reactor 10, including the anoxic zone 18, removes BOD and TSS from the wastewater. Effluent from the upstream reactor, with low BOD and low TSS but variable nitrogen levels, is transferred via outlet 14 to the inlet 22 of the attached growth reactor 20 for nitrification.

As discussed above, the nitrified or treated effluent is removed from the attached growth reactor. Specifically, a recycling volume set at 0.5× to 10× of the incoming raw wastewater volume (set as 1×) entering the upstream reactor 10 is transferred or recycled to a location that is upstream of at least a portion of the anoxic zone 18.

As will be appreciated by one of skill in the art, lower recycle rates require less transfer/recycling and consequently smaller reactors. However, higher recycle rates will result in more total nitrogen removal.

Specifically, a portion of the effluent from the attached growth reactor is returned to an anoxic basin or an anoxic zone within a basin near the front of the treatment system for denitrification. As discussed herein, the primary influent entering the anoxic basin consists of raw wastewater, or minimally treated wastewater which is high in BOD, and may be low in oxygen. However, the nitrified effluent from the attached growth reactor are high in oxygen, which is bound in the form of nitrates or nitrites.

As a result of the recycling of the treated effluent and combining it with the incoming volume of wastewater, bacteria in the wastewater present in the anoxic zone of the upstream reactor consume the SOD from the raw wastewater, utilizing the nitrates from the treated effluent or recycle stream as an oxygen source. Consuming the oxygen from the nitrates releases nitrogen from the wastewater as nitrogen gas. The denitrification reaction uses up BOD, which in turn lowering energy requirements for BOD removal elsewhere in the treatment plant. Utilizing BOD present in the influent wastewater as a carbon source for the denitrification reaction reduces or eliminates the need to add a carbon source to the wastewater treatment system. As such, the efficiency of the entire wastewater treatment process is increased and the treated effluent is much more environmentally acceptable as it is lower in nitrogen.

The invention will now be described by way of examples; however, the invention is not necessarily limited by the examples.

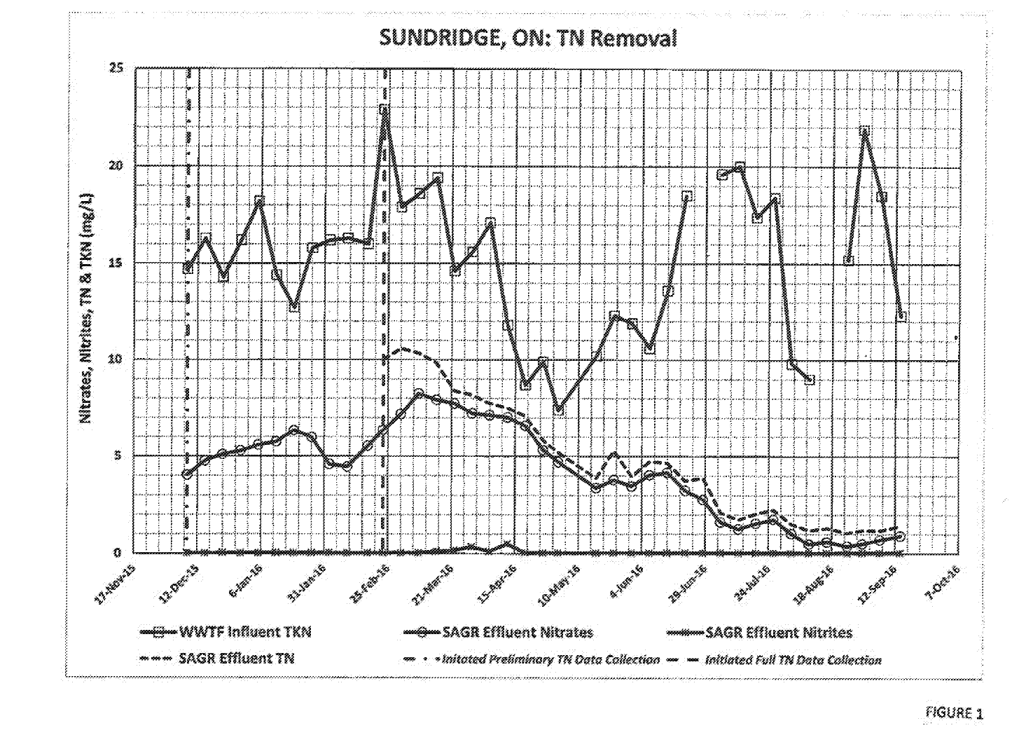

Nitrate/nitrite and TKN levels were measured in a waste treatment system comprising an anoxic reactor and a attached growth reactor arranged for recycling a variable volume of the effluent, as described herein. The summary of sampling, data collection and frequency, shown in FIG. 1, is as follows:
Dec. 8, 2015 to Feb. 17, 2016—took weekly grab samples of raw wastewater and SAGR effluent and tested for TKN and Nitrate/Nitrites, respectively. Analysis of BOD, TSS, Alkalinity, Total Phosphorus and Ammonia was also performed on the raw wastewater samples. Similarly, analysis on SAGR effluent Alkalinity was also performed.
Feb. 23, 2016 to Present—took weekly grab samples of raw wastewater and SAGR effluent and tested for TKN and Nitrate/Nitrites, respectively. Analysis of BOD, TSS, alkalinity, Total Phosphorus and Ammonia was performed on the raw wastewater samples. Similarly, analysis on SAGR effluent Alkalinity and TKN was also performed. The sum of SAGR effluent Nitrate/Nitrates and TKN constitutes the SAGR effluent TN as discussed above.

The recycle rate is estimated to be approximately 60-95% the influent flow rate, that is, of the volume of wastewater entering the lagoon or treatment facility. This flow is an estimate provided by the wastewater facility operator. Data collection to determine the effect of recycling SAGR effluent nitrates/nitrites to an anoxic zone at the front end of the primary treatment cell was initiated in on Dec. 8, 2015 and has continued on a weekly basis until the present time. Initially raw wastewater TKN (Total Kjedhal Nitrogen) along with SAGR effluent nitrate/nitrites were determined as a preliminary step (Dec. 8, 2015 to Feb. 17, 2016) to show that TN removal was taking place within the lagoons.

Raw wastewater TKN was chosen as an indicator of incoming TN (total nitrogen) into the treatment facility because it along with nitrates/nitrites are the constituents of TN. Typically, the raw wastewater influent nitrates/nitrites make up a near zero fraction of TN flowing into any Municipal wastewater treatment facility. TKN, which comprises of TAN (total ammonia as nitrogen) and organically bound nitrogenous compounds, is the majority of raw wastewater TN and as a result, it can be used as a surrogate measure of raw wastewater TN. On the other hand SAGR effluent nitrates/nitrites were used as an indicator of the wastewater treatment facility effluent TN at the onset of data collection. Typically in treatment processes incorporating lagoon based secondary treatment followed by tertiary treatment through the SAGR process, the influent TKN will to a large extent (over 95%) be converted to mainly nitrates. It can therefore be concluded that the treatment facility effluent nitrates are a good indicator of effluent TN.

Based on the preliminary data collection during the period of Dec. 8, 2015 to Feb. 17, 2016, it was concluded that the average TN reduction was 66% percent and more importantly it met the target effluent TN of less than 10 mg/L. The wastewater influent TKN averaged 15.6 mg/L and the effluent nitrates/nitrites averaged 5.2 mg/L within this time period.

At that point, SAGR effluent TN data collection was initiated as of Feb. 23, 2016 to present (i.e. initiated TKN analysis of SAGR effluent). From the 23rd to Sep. 14, 2016, the average TN removal of the facility is 68% with an average influent TN of 14.9 mg/L and effluent TN of 4.8 mg/L.

While the preferred embodiments of the invention have been described above, it will be recognized and understood that various modifications may be made therein, and the appended claims are intended to cover all such modifications which may fall within the spirit and scope of the invention.

1. A method of reducing total nitrogen levels in discharged effluent comprising:
in a sewage treatment system comprising an attached growth reactor and an upstream reactor comprising an anoxic zone, said upstream reactor comprising an inlet for receiving an incoming wastewater volume and an outlet for discharging treated waste, said attached growth reactor comprising an inlet for receiving treated waste from the upstream reactor and an outlet for discharging treated effluent from the attached growth reactor,
transferring an influent volume of treated waste to the attached growth reactor at said inlet,
over a period of time, converting ammonia in said influent to nitrate, thereby producing treated influent,
discharging said treated influent from the attached growth reactor as treated effluent, said discharged treated effluent comprising a recycling volume and a discharge volume,
transferring said recycling volume at a position upstream of at least a portion of the anoxic zone of the upstream reactor, wherein said recycling volume corresponds to 0.5× to 10× of the incoming wastewater volume, and
discharging the discharge volume of the treated effluent.

2. The method according to claim 1 wherein the attached growth reactor is selected from the group consisting of: a submerged attached growth reactor (SAGR), a moving media attached growth reactor (MMAGR) and a stationary media attached growth reactor (SMAGR).

3. The method according to claim 1 wherein the attached growth reactor is a submerged attached growth reactor.

4. The method according to claim 1 further comprising a secondary treatment component that receives treated waste from the upstream reactor comprising the anoxic zone and discharges secondary treated waste to the attached growth reactor.

5. The method according to claim 4 wherein the secondary treatment component is selected from the group consisting of one or more lagoons, septic tanks, mechanical plants, attached growth reactors, clarifiers and combinations thereof.

6. The method according to claim 4 wherein the secondary treatment component is a lagoon.

7. The method according to claim 1 wherein the anoxic zone is within a lagoon.

8. A method of reducing nitrogen levels in discharged effluent comprising:
in a sewage treatment system comprising an attached growth reactor and an upstream reactor comprising an anoxic zone, said upstream reactor comprising an inlet for receiving an incoming wastewater volume and an outlet for discharging treated waste, said attached growth reactor comprising an inlet for receiving the treated waste from the upstream reactor and an outlet for discharging treated effluent from the attached growth reactor, said treated effluent comprising a recycling volume and a discharge volume,
transferring an influent volume of treated waste to the attached growth reactor at said inlet,
transferring the recycling volume of treated effluent from the outlet of the attached growth reactor to a position upstream of the anoxic zone of the upstream reactor, said recycling volume corresponding to 0.5× to 10× of the incoming wastewater volume, and
discharging the discharge volume of the treated waste.

9. The method according to claim 8 wherein the attached growth reactor is selected from the group consisting of: a submerged attached growth reactor (SAGR), a moving media attached growth reactor (MMAGR) and a stationary media attached growth reactor (SMAGR).

10. The method according to claim 8 wherein the attached growth reactor is a submerged attached growth reactor.

11. The method according to claim 8 further comprising a secondary treatment component that receives treated waste from the upstream reactor comprising the anoxic zone and discharges secondary treated waste to the attached growth reactor.

12. The method according to claim 11 wherein the secondary treatment component is selected from the group consisting of one or more lagoons, septic tanks, mechanical plants, attached growth reactors, clarifiers and combinations thereof.

13. The method according to claim 11 wherein the secondary treatment component is a lagoon.

14. The method according to claim 8 wherein the anoxic zone is within a lagoon.

15. A wastewater treatment system comprising:
an upstream reactor comprising:
an inlet arranged to accept an incoming volume of wastewater;
an anoxic zone downstream of the inlet; and
an outlet for discharging a volume of treated wastewater;
an attached growth reactor comprising:
an inlet for receiving treated wastewater from the upstream reactor; and
at least one outlet for releasing a treatment volume of the treated wastewater from the attached growth reactor; and
a recycling system arranged to transfer a portion of the treatment volume from the attached growth reactor to a point in the upstream reactor upstream of the anoxic zone.

16. The wastewater treatment system according to claim 15 wherein the attached growth reactor is selected from the group consisting of: a submerged attached growth reactor (SAGR), a moving media attached growth reactor (MMAGR) and a stationary media attached growth reactor (SMAGR).

17. The wastewater treatment system according to claim 16 wherein the attached growth reactor is a submerged attached growth reactor.

18. The wastewater treatment system according to claim 15 further comprising a secondary treatment component that receives treated waste from the upstream reactor comprising the anoxic zone and discharges secondary treated waste to the attached growth reactor.

19. The wastewater treatment system according to claim 18 wherein the secondary treatment component is selected from the group consisting of one or more lagoons, septic tanks, mechanical plants, attached growth reactors, clarifiers and combinations thereof.

20. The method according to claim 18 wherein the secondary treatment component is a lagoon.

21. The method according to claim 15 wherein the anoxic zone is within a lagoon.
